(19) United States
(12) Patent Application Publication
(10) Pub. No.: US 2026/0028262 A1
(43) Pub. Date: Jan. 29, 2026

(54) Wearable device for purifying impure water and method thereof

(71) Applicant: Vaanya Ahuja, Mansfield, MA (US)

(72) Inventor: Vaanya Ahuja, Mansfield, MA (US)

(21) Appl. No.: 18/786,437

(22) Filed: Jul. 27, 2024

(51) Int. Cl. C02F 9/20; A41D 19/00; C02F 1/00; C02F 1/32; C02F 1/44

(52) U.S. Cl. CPC C02F 9/20; A41D 19/0024; C02F 1/008; C02F 1/002; C02F 1/32; C02F 1/44; C02F 2209/003; C02F 2303/04

(57) ABSTRACT

The present invention discloses a wearable device and a method for purifying impure water. The wearable device comprises a hand-glove, one or more secondary pipes, a filtering unit, a primary pipe, and a container. Further, the hand-glove is configured to be attached to the one or more secondary pipes at an outer surface. A second end of the one or more secondary pipes is connected to the filtering unit. The filtering unit comprises a driving unit, one or more sensors, and a filter. The filtering unit is configured to purify the impure water to generate pure water for storing into the container via the primary pipe. The container is coupled to attachment mechanism to be wore at either back or front of a user. The present invention is advantageous in terms of providing a simple, efficient, inexpensive, lighter in weight, portable and wearable device for purifying impure water.

### FIELD OF DISCLOSURE

The present disclosure is generally related to water purification systems, and more particularly to a wearable device and a method for purifying impure water.

### BACKGROUND

Water purification is a critical process in many situations, particularly in outdoor environments or areas where access to clean water is limited. In remote areas, availability of clean water for drinking is very limited. Further, due to unavailability of resources including power, the traditional water purifiers are difficult to be implemented in such places. The traditional water purification methods often involve the use of large, stationary equipment or small portable devices that may not be convenient or efficient for individual use in certain situations.

One of the primary challenges in this field is the development of a portable, user-friendly device that allows for efficient and effective purification of water in remote locations. Existing solutions often require manual operation, which can be cumbersome and time-consuming. Additionally, these devices may lack the capacity to purify large volumes of water, limiting their utility in situations with high water demand. Furthermore, the need to constantly replenish unclean water can interrupt the purification process, reducing the overall efficiency of these devices.

There have been several attempts to overcome these challenges. For instance, WO-2020083337-A1 discloses a portable automatic water filter with a filter cartridge set and pipe, a water pump, a power supply, and a controller. This device is convenient for outdoor use, has a large water purification capacity, and can meet requirements even for large number of users and high water-consumption demand. However, it still requires manual operation and may not be convenient for individual use.

JP-2013091014-A introduces a bottle-type portable water purifier attached to a container with a suction side check valve and a cap fitted with a filter. Although it allows for continuous replenishment of unclean water, the device requires the user to remove the volume segment of the container to put in water and extract clean water, which can be inconvenient.

CN-207271750-U proposes a breeding pigeon cup cleaning means with gloves, wiper fingerstall, suction hose, connection flexible pipe, elastic balloon, fixed band. While this device eliminates secondary pollution caused by dabbling, it does not address the needs of human users for portable water purification.

Another invention, KR-200317315-Y1 details an automatic pumping device attached to a portable water purifier that can be used manually or automatically depending on the user's needs. The pump includes a case with an inlet and outlet, and a battery unit to supply power. The booster pump is driven by the battery unit and on/off switch. However, this device still requires manual operation for the pumping process, which may not be convenient for all users.

Therefore, there is a need to overcome the problems discussed above. It is desirable to have a portable device that allows for the efficient and effective purification of water, which can be operated automatically and has the capacity to purify large volumes of impure water. The device should be convenient for individual use in a variety of situations and should not require constant replenishment of unclean water or manual operation for the purification process.

### SUMMARY

A wearable device for purifying impure water in accordance with the present disclosure comprises a hand-glove, a filtering unit, a primary pipe, one or more secondary pipes, and a container. The hand-glove is configured to be worn by a user. The one or more secondary pipes are configured to be attached to the hand-glove for receiving the impure water. The filtering unit is configured to be coupled to the hand-glove to receive the impure water through the one or more secondary pipes. Further, the filtering unit is configured to purify the impure water to generate pure water. The primary pipe is configured to be coupled to the filtering unit to receive the pure water. The container is configured to be coupled to the primary pipe to receive the pure water through the primary pipe and store the pure water.

In an embodiment of the present disclosure, the one or more secondary pipes are configured to be attached to an outer surface of the hand-glove covering fingers. The outer surface corresponds to a surface exposed to environment when the hand-glove is worn by the user.

In an embodiment of the present disclosure, the filtering unit comprises a suction pump, a driving unit, a filter, an input unit, one or more sensors, a processor, and an output unit. The suction pump is configured to draw the impure water through the one or more secondary pipes. The driving unit is configured to operate the suction pump to draw the impure water. The filter is configured to filter the impure water to generate the pure water. The input unit is configured to receive inputs from the user. The one or more sensors are configured to measure the one or more parameters corresponding to the purity of the pure water. The processor is configured to determine a purity level of the pure water generated by the filter and transmit the purity level of the pure water generated by the filter to the output unit. The output unit is configured to display the purity level of the generated pure water.

In an embodiment of the present disclosure, the filtering unit is present in a hand-band.

In an embodiment of the present disclosure, the hand-band comprises a tube comprising a first segment, a second segment and a third segment. The first segment is configured to carry impure water for purification. The second segment comprises the filtering unit. The filtering unit is configured for the purification of the impure water to generate the pure water. The third segment is configured to carry the pure water generated by the one or more filters in the second segment. Further, the first segment, the second segment, and the third segment are detachably coupled to each other to form the tube of the hand-band.

In an embodiment of the present disclosure, the hand-band is configured to be wearable on a wrist of the user. The hand-band is configured to be detachably coupled to the outer surface of the hand-glove.

A method for purifying impure water in accordance with the present disclosure is illustrated. The method is configured to be performed on wearable device comprising a hand-glove, a primary pipe, one or more secondary pipes, a filtering unit, a container, and straps. The filtering unit comprises a suction pump, a driving unit, a processor, a filter, one or more sensors, an input unit, and an output unit. The method comprising wearing by the user, the hand-glove on a hand of the user. Further, the method comprises immersing by the user, a first end of the one or more secondary pipes that are attached to each finger of the hand-glove, in the impure water to be purified. The method includes activating by the user, the driving unit, the filter, the processor, and the one or more sensors, using the input unit. The method involves allowing by the driving unit, via a suction pump, a flow of the impure water inside the one or more secondary pipes. The method further comprises filtering by the filter, the impure water for purification to generate pure water. Also, the method comprises sensing by the one or more sensors, a measurement of purity of the generated pure water. Furthermore, the method comprises transmitting by the one or more sensors, the measurement of purity of the generated pure water to the processor. Moreover, the method also includes storing by the container, the generated pure water using the primary pipe as the container is attached to the primary pipe.

In an embodiment of the present disclosure, the wearable device comprising the container is configured to be wearable by the user at either front or back of the user, via an attachment mechanism. The attachment mechanism comprises the straps.

In an embodiment of the present disclosure, the driving unit is either a manual driving unit or an electrical driving unit that is configured to create a suction force by operating the suction pump for allowing a flow of the impure water inside the one or more secondary pipes when a first end of the one or more secondary pipes are immersed in the impure water. The electrical driving unit is a motor.

In an embodiment of the present disclosure, the filter comprises a filter media, a semi-permeable membrane, a UV lamp, and a pre-filter. The filter media is made up of activated carbon ceramic, and the like.

### BRIEF DESCRIPTION OF DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an exemplary wearable device for purifying impure water in accordance with the present disclosure.

FIG. 2 illustrates an exemplary filtering unit of the wearable device in accordance with the present disclosure.

FIG. 3a illustrates an exemplary representation of a user wearing the wearable device in accordance with the present disclosure.

FIG. 3b illustrates another exemplary representation of the user wearing the wearable device in accordance with the present disclosure.

FIG. 4 illustrates an exemplary representation of a hand-band of the wearable device in accordance with the present disclosure.

FIG. 5 illustrates an exemplary representation of the user wearing the hand-band of the wearable device in accordance with the present disclosure.

FIG. 6 illustrates an exemplary flowchart of a method for purifying impure water in accordance with the present disclosure.

### LIST OF REFERENCE NUMERALS

100—wearable device
102—hand-glove
104—one or more secondary pipes
106—primary pipe
108, 412—filtering unit
110—container
112—attachment mechanism
202—suction pump
204—driving unit
206—filter
208—one or more sensors
210—processor
212—input unit
214—output unit
400—hand-band
402—tube
402a—first segment
402b—second segment
402c—third segment
404—plug
406—first membrane
408—second membrane
410—divider
600—Method

### DETAILED DESCRIPTION

Embodiments of the present invention are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

As used herein, the term “exemplary” or “illustrative” means “serving as an example, instance, or illustration.” Any implementation described herein as exemplary or illustrative is not necessarily to be construed as advantageous and/or preferred over other embodiments. Unless the context requires otherwise, throughout the description and the claims, the word “comprise” and variations thereof, such as “comprises” and “comprising” are to be construed in an open, inclusive sense, i.e., as “including, but not limited to.”

This disclosure is generally drawn, inter alia, to methods, apparatuses, systems, devices implemented as tools for purifying impure water.

FIG. 1 illustrates an exemplary wearable device 100 for purifying impure water in accordance with the present disclosure. The wearable device 100 comprises a hand-glove 102, a filtering unit 108, one or more secondary pipes 104, a primary pipe 106, a container 110, and attachment mechanism 112. The filtering unit 108 comprises a suction pump 202, a driving unit 204, a filter, one or more sensors 208, a processor 210, an input unit 212, and an output unit 214.

The one or more secondary pipes 104 are configured to be attached to an outer surface of the hand-glove 102 covering fingers. The outer surface corresponds to a surface exposed to environment when the hand-glove 102 is worn by the user. The one or more secondary pipes 104 comprises a first end and a second end. The first end being extended beyond the fingertips of the hand-glove 102 for drawing the impure water therethrough when immersed in the impure water. The one or more secondary pipes 104 are configured to carry a flow of the impure water from the water resource to the filtering unit 108 for purification to generate the pure water for drinking or other purposes. The second end of the one or more secondary pipes 104 is configured to be attached to the filtering unit 108. The filtering unit 108 is configured to be coupled to the hand-glove 102 to receive the impure water through the one or more secondary pipes 104 and purify the impure water to generate the pure water for further use. The filtering unit 108 comprises at least one ingress configured to be connected with the second end of each of the one or more secondary pipes 104 and at least one egress configured to be connected with the primary pipe 106. Further, the primary pipe 106 is configured to be coupled to the filtering unit 108 to receive the pure water. The primary pipe 106 comprises an inlet port and an outlet port. The inlet port of the primary pipe 106 is connected to the egress of the filtering unit 108 and the outlet port being connected to the container 110 of the wearable device 100. The container 110 is configured to be coupled to outlet port of the primary pipe 106 to store the pure water received through the primary pipe 106. The container 110 is configured to be attached with attachment mechanism 112. The container 110 is configured to be wearable by the user via the attachment mechanism 112. In an embodiment, the outlet port of the primary pipe 106 is detachable with the container 110 for directly drinking the pure water generated by the filtering unit 108 by the user. In another embodiment, the user may also provide a suction force via mouth of the user from the outlet port of the primary pipe 106 to allow the flow of impure water inside the one or more secondary pipes 104 and the filtering unit 108, and the flow of the pure water in the primary pipe 106.

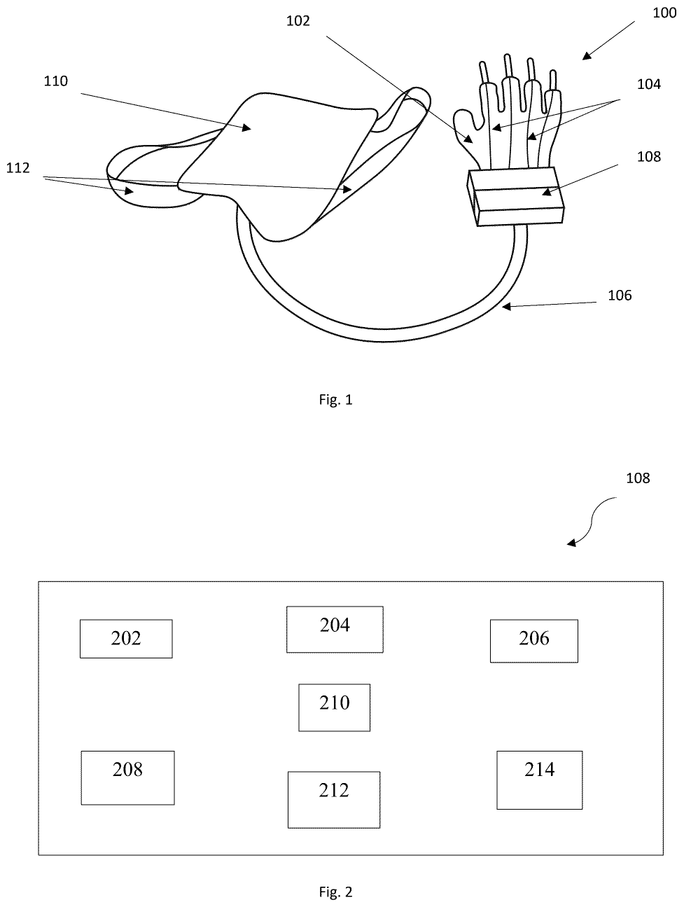

FIG. 2 illustrates an exemplary filtering unit 108 of the wearable device 100 in accordance with the present disclosure. The filtering unit 108 comprises the suction pump 202, the driving unit 204, the processor 210, the one or more sensors 208, the filter, the input unit 212, and the output unit 214. The processor 210 is communicatively coupled to the one or more sensors 208, the filter, the driving unit 204, the input unit 212, and the output unit 214 via wired or wireless connections. The filter 206 of the wearable device 100 is configured to perform various operations for the purification of the impure water. The input unit 212 is configured to receive inputs from the user. The input unit 212 is configured to activate and deactivate the processor 210, the driving unit 204, the one or more sensors 208, and the filter 206 of the wearable device 100. The wearable device 100 is activated and deactivated based on the commands given to the input unit 212 by the user wearing the wearable device 100. In an embodiment, the input unit 212 comprises a power button that is configured to activate all the components of the filtering unit 108, for e.g., the processor 210, the driving unit 204, the one or more sensors 208, and the filter. In another embodiment, the input unit 212 comprises a keyboard or a touchscreen having multiple keys for giving proper instructions to the wearable device 100. The suction pump 202 is configured to draw the impure water through the one or more secondary pipes 104. The driving unit 204 of the filtering unit 108 is configured to create a suction force via the suction pump 202 to draw the impure water in the one or more secondary pipes 104. In an embodiment, the processor 210 is configured to operate the suction pump 202 via transmitting corresponding signals to the driving unit 204. When the first end of the one or more secondary pipes 104 is immersed in the impure water to be purified, the suction force created by the driving unit 204 within the one or more secondary pipes 104 allows the flow of impure water inside the one or more secondary pipes 104. In an embodiment, the driving unit 204 is a manual driving unit or an electrical driving unit 204 that is configured to create a suction force for allowing a flow of the impure water inside the one or more secondary pipes 104 when a first end of the one or more secondary pipes 104 are immersed in the impure water. Further, the electrical driving unit 204 is a motor. The filter 206 is configured to purify the impure water derived from the water resource via the one or more secondary pipes 104 using the suction force created by the driving unit 204. The filter 206 unit is configured to generate the pure water for the drinking and other purposes. In an embodiment, the filter 206 comprises filter media, a semi-permeable membrane, a UV lamp, and a pre-filter, the filter media is made up of activated carbon, ceramic, and the like. The pure water generated by the filter 206 is stored in the container 110 for later use. Further, the one or more sensors 208 are configured to measure purity of the pure water generated by the filter. The one or more sensors 208 comprise various sensors for measuring the purity of the generated pure water in terms of one or more parameters of purity. The one or more sensors 208 comprise pH sensors, turbidity sensors, conductivity sensors, dissolved oxygen sensors, heavy metal sensors, organic compound sensors, etc. The one or more parameters comprise turbidity, colour, pH, chlorine residual, total dissolved solids, microbial contents, heavy metals, chemical contents, and a combination thereof. The one or more sensors 208 are further configured to transmit the measurement of purity in terms of the one or more parameters to the processor 210. The processor 210 is configured to process various calculations within the wearable device 100 for purifying impure water to determine a purity level of the pure water generated by the filter 206 to the output unit 214. The output unit 214 is configured to output the purity level of the pure water generated by the filter. The output unit 214 may be selected from any one of an LED display, a touchscreen, and a speaker, and a combination thereof. Furthermore, the output unit 214 is configured to disclose an output to the user of the wearable device 100. The output may comprise an audio sound or a display. In an embodiment, the output unit 214 may provide a consolidated output comprising the percentage of purity of the generated pure water. In another embodiment, the output unit 214 may provide the detailed output disclosing every parameter of purity corresponding to the pure water generated by the filter.

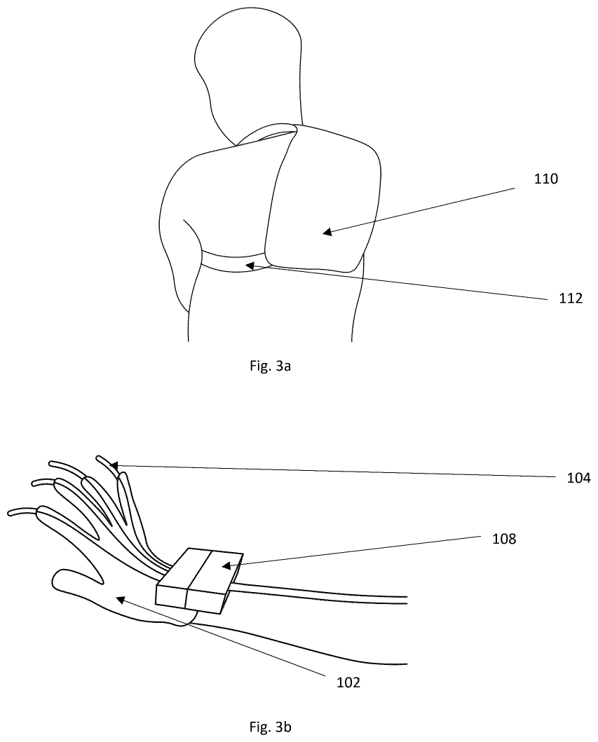

FIG. 3a illustrates an exemplary representation of the user wearing the wearable device 100 in accordance with the present disclosure. The wearable device 100 comprises attachment mechanism 112 for wearing the container 110 of the wearable device 100 either at the back or the front of the user. In an embodiment, the attachment mechanism 112 comprises straps. The container 110 is configured to carry the pure water generated by the filter 206 of the wearable device 100. The pure water is stored in the container 110 for further use. In an embodiment, the container 110 is made up of plastic that is BPA-free or made from food-grade plastics. The attachment mechanism 112 are coupled to the container 110 via some form of coupling means. In an embodiment, the attachment mechanism 112 are configured to be detached from the container 110 via detaching the attachment mechanism 112 from the coupling means. In an embodiment, the attachment mechanism 112 are made up of stretchable material for ease of wearing. In an embodiment, the container 110 and the attachment mechanism 112 are made up of lighter material so as not to increase an overall weight of the wearable device 100.

FIG. 3b illustrates another exemplary representation of the user wearing the wearable device 100 in accordance with the present disclosure. The wearable device 100 comprising the hand-glove 102 worn by the user in one hand of the user. In an embodiment, the hand-glove 102 is of a left hand. In another embodiment, the hand-glove 102 is of a right hand. The hand-glove 102 is configured to be attached to the one or more secondary pipes 104 and coupled to the filtering unit 108. In an embodiment, the one or more secondary pipes 104 are attached to the hand-glove 102 via covering the fingers of the hand-glove 102. The first ends of the one or more secondary pipes 104 extends beyond the hand-glove 102 to allow for dipping/immersing the first ends by the user in any of the water resource for filling the impure water in the one or more secondary pipes 104 to be purified. The filtering unit 108 is connected to the one or more secondary pipes 104 and to the primary pipe 106 via the at least one ingress and the at least one egress respectively of the filtering unit 108. In an embodiment, the primary pipe 106 is also attached to the hand-glove 102.

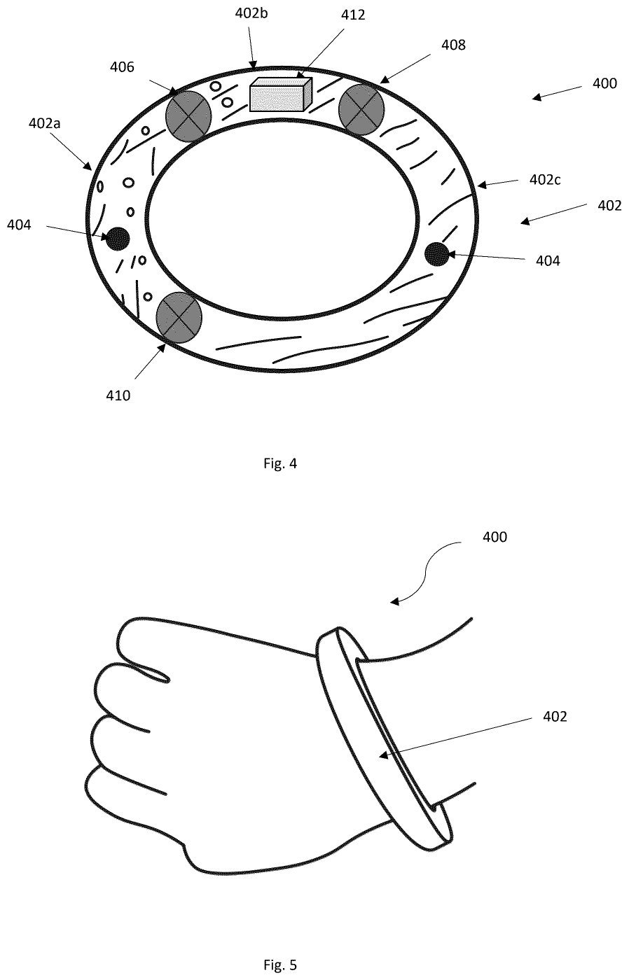

FIG. 4 illustrates an exemplary representation of a hand-band 400 of the wearable device 100 in accordance with the present disclosure. The wearable device 100 comprises a hand-band 400. The hand-band 400 is enclosing the filtering unit 412 of the wearable device 100. The hand-band 400 comprises a tube 402 comprising a first segment 402a, a second segment 402b, and a third segment 402c. The first segment 402a of the tube 402 is configured to carry the impure water from the water resource for purification. The second segment 402b comprises the filtering unit 412 for purifying the impure water to generate the pure water. The third segment 402c is configured to carry the generated pure water from the second segment 402b. Further, the first segment 402a, the second segment 402b and the third segment 402c are detachably coupled to each other to form the tube 402 of the hand-band 400. In an embodiment, the first segment 402a, the second segment 402b and the third segment 402c are coupled to each other inseparably. The filtering unit 412 comprises the suction pump, the driving unit, the processor, the one or more sensors, the filter, the input unit, and the output unit. The processor is communicatively coupled to the one or more sensors (not shown), the filter (not shown), the driving unit (not shown), the input unit (not shown), and the output unit (not shown) via wired or wireless connections. The input unit is configured to receive inputs from the user. The input unit is configured to activate and deactivate the processor, the driving unit, the one or more sensors, and the filter of the wearable device 100. The suction pump is configured to draw the impure water through the one or more secondary pipes (not shown). The driving unit of the filtering unit 412 is configured to create a suction force via the suction pump to draw the impure water in the one or more secondary pipes, when the first end of the one or more secondary pipes is immersed in the impure water to be purified. In an embodiment, the processor is configured to operate the suction pump via transmitting corresponding signals to the driving unit. In an embodiment, the driving unit is a manual driving unit or an electrical driving unit that is configured to create a suction force for allowing a flow of the impure water inside the one or more secondary pipes when the first end of the one or more secondary pipes are immersed in the impure water. Further, the electrical driving unit is a motor. The filter is configured to purify the impure water derived from the water resource via the one or more secondary pipes using the suction force created by the driving unit. In an embodiment, the filter comprises filter media, a semi-permeable membrane, a UV lamp, and a pre-filter, the filter media is made up of activated carbon, ceramic, and the like. The pure water generated by the filter is stored in the container (not shown) for later use. Further, the one or more sensors are configured to measure purity of the pure water generated by the filter. The one or more sensors comprise pH sensors, turbidity sensors, conductivity sensors, dissolved oxygen sensors, heavy metal sensors, organic compound sensors, etc. The one or more sensors are further configured to transmit the measurement of purity in terms of the one or more parameters to the processor. The one or more parameters comprise turbidity, colour, pH, chlorine residual, total dissolved solids, microbial contents, heavy metals, chemical contents, and a combination thereof. The processor is configured to determine a purity level of the pure water generated by the filter to the output unit. The output unit is configured to output the purity level of the pure water generated by the filter.

In an embodiment of the present disclosure, each of the first segment 402a and the third segment 402c comprise a plug 404 for filling the impure water and withdrawing the generated pure water respectively.

In an embodiment of the present disclosure, the plug 404 at the first segment 402a is connected to the second end of the one or more secondary pipes 104 and the plug 404 at the second segment 402b is connected to the inlet port of the primary pipe 106.

In an embodiment of the present disclosure, the hand-band 400 comprises a first membrane 406, a second membrane 408, and a divider 410. The first membrane 406 is coupled between the first segment 402a and the second segment 402b. The second membrane 408 is coupled between the second segment 402b and the third segment 402c. Further, the divider 410 is coupled between the third segment 402c and the first segment 402a.

In an embodiment of the present disclosure, the first membrane 406 is configured to allow the flow of impure water from the first segment 402a to the second segment 402b but not vice-versa. The second membrane 408 is configured to allow the flow of pure water from the second segment 402b to the third segment 402c but not vice-versa. Further, the divider 410 is configured to block the flow between the first segment 402a and the third segment 402c.

FIG. 5 illustrates an exemplary representation of the user wearing the hand-band 400 of the wearable device 100 in accordance with the present disclosure. The hand-band 400 comprising the tube 402 is configured to be wearable at the hand of the user. The tube 402 of the hand-band 400 comprises the first segment 402a, the second segment 402b and the third segment 402c. The first segment 402a, the second segment 402b and the third segment 402c are detachably coupled to each other to thereby allow ease of wearing or removing the tube 402 from the wrist of the user. In an embodiment, the hand-band 400 is configured to be wearable on a wrist of the user. In an embodiment, the hand-band 400 is configured to be detachably coupled to the outer surface of the hand-glove. In an embodiment, the tube 402 of the hand-band 400 is made up of a material that is lighter in weight. In an embodiment, the tube 402 of the hand-band 400 is transparent in color. In an embodiment, the tube 402 of the hand-band 400 is made up of stretchable material for ease of wearing. In another embodiment, the tube 402 of the hand-band 400 is made-up of rigid material.

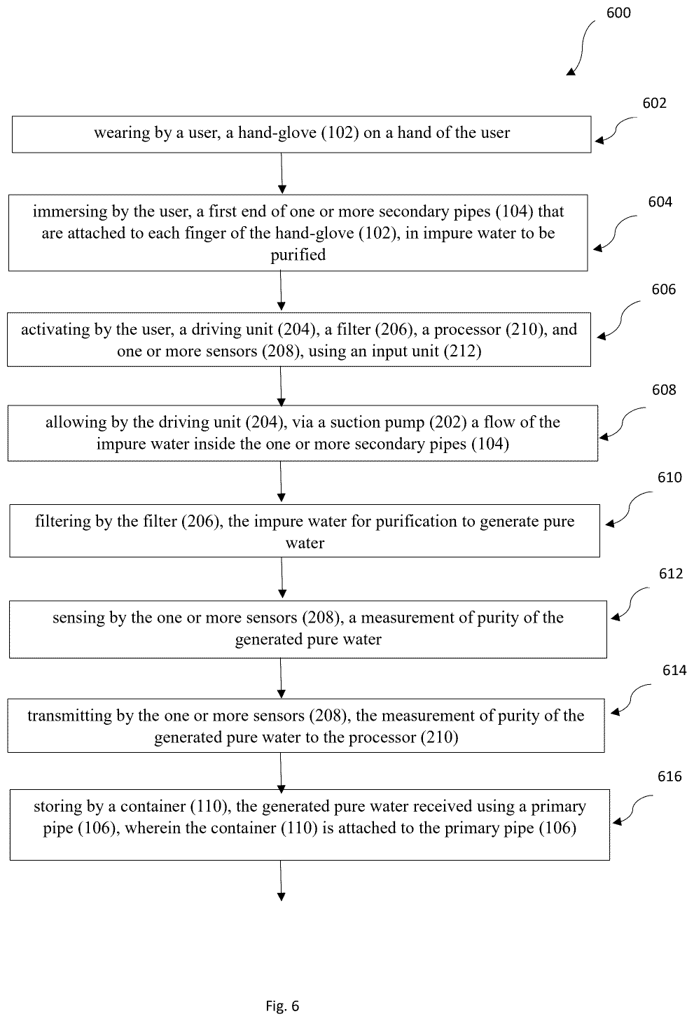

FIG. 6 illustrates an exemplary flowchart of a method 600 for purifying impure water in accordance with the present disclosure. The method 600 is configured to be performed on the wearable device 100 comprising the hand-glove 102, the primary pipe 106, the one or more secondary pipes 104, the filtering unit 108, 412 the container 110, and the attachment mechanism 112. The filtering unit 108, 412 comprising the suction pump 202, the driving unit 204, the processor 210, the filter, the one or more sensors 208, the input unit 212, and the output unit 214. The primary pipe 106 comprising the inlet port and the outlet port. The one or more secondary pipes 104 comprising the first end and the second end. The hand-glove 102 is attached to the one or more secondary pipes 104. The hand-glove 102 is also coupled to the filtering unit 108, 412. The second end of the one or more secondary pipes 104 is connected to the at least one ingress of the filtering unit 108, 412 and the inlet port of the primary pipe 106 is connected to the at least one egress of the filtering unit 108, 412. The outlet port of the primary pipe 106 is coupled to the container 110. The container 110 is coupled to the attachment mechanism 112 that are configured to be wearable by the user. The method 600 comprising the following steps:

In step 602, the method 600 comprises wearing by the user, the hand-glove 102 on the hand of the user. The wearable device 100 comprising the hand-glove 102 is attached with the one or more secondary pipes 104 and coupled to the filtering unit 108, 412 at the outer surface of the hand-glove 102.

In step 604, the method 600 includes immersing by the user, the first end of the one or more secondary pipes 104 that are attached to each finger of the hand-glove 102, in the impure water to be purified. The impure water is taken from the water resource that may be available nearby. To purify water for drinking and other purposes, the user puts the hand wearing the hand-glove 102 in the water resource. When the user puts the hand-glove 102 in the water resource, the first ends of the one or more secondary pipes 104 are simultaneously immersed in the water resource.

In step 606, the method 600 comprises activating by the user, the driving unit 204, the filter, the processor 210, and the one or more sensors 208 using the input unit 212. The input unit 212 is configured to receive inputs from the user. The input unit 212 is configured to activate and/or deactivate the various components of the filtering unit 108, 412 as required by the user for the water purification. The input unit 212 may be a power button that is configured to activate all the components of the filtering unit 108, 412. The input unit 212 may also be the keyboard or the LED display for providing proper instructions to the filtering unit 108, 412.

In step 608, the method 600 involves allowing by the driving unit 204, via the suction pump 202, the flow of the impure water inside the one or more secondary pipes 104. The driving unit 204 is configured to provide the suction force for allowing the impure water inside the one or more secondary pipes 104, when the first end of the one or more secondary pipes 104 are immersed in the water resource. In an embodiment, the processor 210 is configured to operate the suction pump 202 via transmitting corresponding signals to the driving unit 204. The driving unit 204 is either the manual driving unit 204 or the electrical driving unit 204 which is configured to create the suction force by operating the suction pump 202 for allowing a flow of the impure water inside the one or more secondary pipes 104 when the first end of the one or more secondary pipes 104 are immersed in the impure water. Further, the electrical driving unit 204 is the motor.

In step 610, the method 600 includes filtering by the filter, the impure water for purification to generate the pure water. The impure water to be treated is taken by the filtering unit 108, 412. In an embodiment, the filtering unit 108, 412 is present in the hand-band 400. The filtering unit 108, 412 comprises the filter 206 for purifying water within the filtering unit 108, 412. The filter 206 is configured to generate the pure water from the impure water received from the water resource. The filter 206 comprises the filter media, the semi-permeable membrane, the UV lamp, and the pre-filter, the filter media is made up of activated carbon, ceramic, and the like.

In step 612, the method 600 comprises sensing by the one or more sensors 208, the measurement of purity of the generated pure water. The one or more sensors 208 are configured to sense the purity of the generated pure water from the filter. The one or more sensors 208 comprise various sensors for measuring the purity of the generated pure water in terms of the one or more parameters of purity. The one or more sensors 208 comprise pH sensors, turbidity sensors, conductivity sensors, dissolved oxygen sensors, heavy metal sensors, organic compound sensors, etc. The one or more sensors 208 are configured for measuring the one or more parameters corresponding to the purity of the pure water generated by the filter. The one or more parameters comprise turbidity, colour, pH, chlorine residual, total dissolved solids, microbial contents, heavy metals, chemical contents, and a combination thereof.

In step 614, the method 600 comprises transmitting by the one or more sensors 208, the measurement of purity of the generated pure water to the processor 210. The measurement of purity for the pure water generated by the filter 206 is based on various parameters of the purity of the water. The processor 210 is configured for determining the purity level of the pure water generated by the filter 206 and transmit the purity level to the output unit 214 for display.

In step 616, the method 600 comprises storing by the container 110, the generated pure water received using the primary pipe 106. The primary pipe 106 comprises the inlet port and the outlet port. The inlet port being connected to the ingress of the filtering unit 108, 412. Further, the outlet port of the primary pipe 106 is coupled to the container 110 for storing the pure water generated by the filtering unit 108, 412. The container 110 is attached with attachment mechanism 112 that are configured to be worn by the user for carrying the container 110 with the user. In an embodiment, the attachment mechanism 112 comprises straps. In an embodiment, the outlet port of the primary pipe 106 is detachable with the container 110 for directly drinking the pure water generated by the filtering unit 108, 412 via the outlet port. The user may also provide the suction force from the outlet port of the primary pipe 106 to allow the flow of water inside the one or more secondary pipes 104. Further, the container 110 may also be detached from the primary pipe 106 for storing the generated pure water in some other vessel.

In an embodiment, the container 110 is configured to be wearable by the user, at either front or back of the user, via the straps 112 of the container 110.

In an embodiment, the filtering unit 108, 412 is configured to couple at the outer surface of the hand-glove 102. The filtering unit 108, 412 is further coupled to the second end of the one or more secondary pipes 104 and the lower end of the primary pipe 106.

Accordingly, the wearable device 100 of the present disclosure is advantageous in terms of providing an efficient and effective wearable device 100 and a method 600 for purifying impure water. In conventional devices, there is a problem of handling the devices for water purification in terms of weight of the device. The conventional devices are not efficient to be taken everywhere for purifying water without much hassle. Also, the presently existing devices and methods do not provide convenience to the user. The present devices do not provide automation for the water purification without much manual intervention and constantly requires manual operation. Presently, there is a need of having such devices that enables the user to purify the water without much hassle and manual intervention. Hence, the present disclosure is advantageous in terms of providing the wearable device 100 and the method 600 for purifying impure water. The wearable device 100 is portable wearable solution for purifying the water for drinking and other purposes. The wearable device 100 is an ideal solution for remote locations or during outdoor activities. The wearable device 100 is worn by the user to be easily taken to different locations. Further, the wearable device 100 is user friendly with intuitive controls and a comfortable design. Furthermore, the wearable device 100 ensures the production of clean, safe drinking water, contributing to the health and well-being of the users. Moreover, the wearable device 100 is lighter in weight and is convenient to be used in a variety of situations and does not require constant replenishment of unclean water or manual operation for the purification process.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner.

1. A wearable device for purifying impure water, the wearable device comprises:
a hand-glove configured to be worn by a user;
one or more secondary pipes configured to be attached to the hand-glove to receive the impure water;
a filtering unit configured to be coupled to the hand-glove to receive the impure water through the one or more secondary pipes and purifying the impure water to generate pure water;
a primary pipe configured to be coupled to the filtering unit to receive the pure water; and
a container configured to be coupled to the primary pipe to receive the pure water through the primary pipe and storing the pure water.

2. The wearable device of claim 1, wherein each of the one or more secondary pipes comprises a first end and a second end, the first end being extended beyond the fingertips of the hand-glove for drawing the impure water therethrough when immersed in the impure water and the second end being attached to the filtering unit.

3. The wearable device of claim 1, wherein each of the one or more secondary pipes are configured to be attached to an outer surface of the hand-glove covering fingers, wherein the outer surface corresponds to a surface exposed to environment when the hand-glove is worn by the user.

4. The wearable device of claim 1, wherein the filtering unit comprises:
a suction pump configured to draw the impure water through the one or more secondary pipes;
a driving unit configured to operate the suction pump to draw the impure water; and
a filter configured to filter the impure water to generate the pure water.

5. The wearable device of claim 4, wherein the filtering unit further comprises:
an input unit configured to receive inputs from the user;
one or more sensors for measuring one or more parameters corresponding to the purity of the pure water, wherein the one or more parameters comprise turbidity, colour, pH, chlorine residual, total dissolved solids, microbial contents, heavy metals, chemical contents, and a combination thereof;
a processor configured to determine a purity level of the pure water generated by the filter and transmit the purity level of the pure water generated by the filter; and
an output unit configured to output the purity level of the pure water generated by the filter.

6. The wearable device of claim 4, wherein the driving unit is a manual driving unit or an electrical driving unit which is configured to create a suction force for allowing a flow of the impure water inside the one or more secondary pipes when a first end of the one or more secondary pipes are immersed in the impure water, wherein the electrical driving unit is a motor.

7. The wearable device of claim 5, wherein the input unit is configured to activate and deactivate the driving unit, the one or more sensors, the processor, and the filter.

8. The wearable device of claim 2, wherein the filtering unit comprises at least one ingress configured to be connected with the second end of each of the one or more secondary pipes and at least one egress configured to be connected with the primary pipe.

9. The wearable device of claim 8, wherein the primary pipe comprises an inlet port and an outlet port, the inlet port being connected to the egress of the filtering unit, and the outlet port being connected to a container of the wearable device.

10. The wearable device of claim 4, wherein the filter comprises a filter media, a semi-permeable membrane, a UV lamp, and a pre-filter, the filter media is made up of activated carbon, ceramic, and the like.

11. The wearable device of claim 1, wherein the container is configured to be wearable by the user, at either front or back of the user, via an attachment mechanism, wherein the attachment mechanism comprises straps.

12. The wearable device of claim 1, wherein the filtering unit is present in a hand-band.

13. The wearable device of claim 11, wherein the hand-band comprises:
a tube comprising:
a first segment configured to carry impure water for purification;
a second segment comprises the filtering unit, the filtering unit is configured for the purification of the impure water to generate pure water; and
a third segment configured to carry the pure water generated by the one or more filters in the second segment, wherein the first segment, the second segment and the third segment are detachably coupled to each other to form the tube of the hand-band.

14. The wearable device of claim 12, wherein each of the first segment and the third segment of the tube comprise a plug for filling the impure water and withdrawing the generated pure water respectively.

15. The wearable device of claim 13, wherein the plug at the first segment is connected to a second end of one or more secondary pipes and the plug at the second segment is connected to an inlet port of a primary pipe.

16. The wearable device of claim 12, wherein the hand-band comprises a first membrane, a second membrane and a divider, the first membrane is coupled between the first segment and the second segment, the second membrane is coupled between the second segment and the third segment, and the divider is coupled between the third segment and the first segment.

17. The wearable device of claim 15, wherein the first membrane is configured to allow a flow of impure water from the first segment to the second segment but not vice-versa, the second membrane is configured to allow a flow of pure water from the second segment to the third segment but not vice-versa, and the divider is configured to block the flow between the first segment and the third segment.

18. The wearable device of claim 11, wherein the hand-band is configured to be wearable on a wrist of a user, the hand-band is configured to be detachably coupled to an outer surface of hand-glove.

19. A method for purifying impure water, the method is configured to be performed on a wearable device comprising a hand-glove, a primary pipe, one or more secondary pipes, a filtering unit comprising a suction pump, a driving unit, a processor, a filter, one or more sensors, an input unit, and an output unit, and a container, the method comprising:
wearing by a user, the hand-glove on a hand of the user;
immersing by the user, a first end of the one or more secondary pipes that are attached to each finger of the hand-glove, in the impure water to be purified;
activating by the user, the driving unit, the filter, the processor, and the one or more sensors, using the input unit;
allowing by the driving unit, via the suction pump a flow of the impure water inside the one or more secondary pipes;
filtering by the filter, the impure water for purification to generate pure water;
sensing by the one or more sensors, a measurement of purity of the generated pure water;
transmitting by the one or more sensors, the measurement of the purity of the generated pure water to the processor; and
storing by the container, the generated pure water received using the primary pipe, wherein the container is attached to the primary pipe.

20. The method of claim 19, wherein the container is configured to be wearable by the user, at either front or back of the user, via an attachment mechanism, wherein the attachment mechanism comprises straps.

21. The method of claim 19, wherein the filtering unit is configured to be attached at an outer surface of the hand-glove, the filtering unit comprises at least one ingress configured to be connected with the second end of each of the one or more secondary pipes and at least one egress configured to be connected with the primary pipe.

22. The method of claim 21, wherein the primary pipe comprises an inlet port and an outlet port, the inlet port being connected to the egress of the filtering unit, and the outlet port being connected to a container of wearable device.

23. The method of claim 19, wherein the one or more sensors are configured for measuring one or more parameters corresponding to the purity of the pure water generated by the filter, wherein the one or more parameters comprise turbidity, colour, pH, chlorine residual, total dissolved solids, microbial contents, heavy metals, chemical contents, and a combination thereof.

24. The method of claim 19, wherein the processor is configured for determining a purity level of the pure water generated by the filter and transmit the purity level to the output unit for display.

25. The method of claim 19, wherein the driving unit is either a manual driving unit or an electrical driving unit which is configured to create a suction force by operating the suction pump for allowing a flow of the impure water inside the one or more secondary pipes when a first end of the one or more secondary pipes are immersed in the impure water, wherein the electrical driving unit is a motor.

26. The method of claim 19, wherein the input unit is configured for receiving inputs from the user, the input unit is further configured to activate and deactivate the driving unit, the one or more sensors, the processor, and the filter.

27. The method of claim 19, wherein the filter comprises a filter media, a semi-permeable membrane, a UV lamp, and a pre-filter, the filter media is made up of activated carbon, ceramic, and the like.

28. The method of claim 19, wherein the filtering unit is present in a hand-band.
